(19) United States
(12) Patent Application Publication
(10) Pub. No.: US 2024/0045726 A1
(43) Pub. Date: Feb. 8, 2024

(54) RUNTIME-SUSTAINED QOS AND OPTIMIZED RESOURCE EFFICIENCY

(71) Applicant: HEWLETT PACKARD ENTERPRISE DEVELOPMENT LP, Houston, TX (US)

(72) Inventors: KENNETH LEACH, Austin, TX (US); DEJAN S. MILOJICIC, Milpitas, CA (US); MAXIM ALT, San Jose, CA (US)

(21) Appl. No.: 17/875,273

(22) Filed: Jul. 27, 2022

(51) Int. Cl. G06F 9/50

(52) U.S. Cl. CPC G06F 9/505

(57) ABSTRACT

Systems and methods are provided for maintaining a desired efficiency of use of resources in a computing system, such as a high performance computing (HPC) system in conjunction with a desired quality of service (QoS) associated with performance of an application executed by the resources. Efficiency and QoS may be considered together, and the provided systems and methods optimize both during application runtime.

### BACKGROUND

Supercomputing once was exclusive to governmental or medical researchers, high-cost movie makers, and the like. However, with the implementation and use of data-intensive technologies, such as artificial intelligence or machine learning (which can require massively parallel computing (MPC) computing capabilities) becoming more ubiquitous, more entities and users are exploring high-performance computing (“HPC”) applications or solutions. These applications or solutions may run on a variety of platforms such as, for example, supercomputers, clusters, and the cloud, and are used in fields as diverse as medical imaging, financial services, molecular biology, energy, cosmology, geophysics, manufacturing, and data warehousing, among others. A common challenge affecting HPC applications is their need to accelerate the processing of vast amounts of data (e.g., in the teraflops or petaflops) among multiple processors or processor core.

The term “cloud computing” generally denotes the use of relatively large amounts of computing resources provided by a third party over a private or public network. For instance, a business entity might have large amounts of data that it wants to store, access, and process without having to build its own computing infrastructure for those purposes. The business entity might then lease or otherwise pay for computing resources belonging to a third party or, in this context, a “cloud provider”. The business entity is a “client” of the cloud provider in this context. The cloud provider might provide the computing resources to the business entity over, in some cases, the World Wide Web of the Internet. HPC applications or solutions often leverage the cloud.

### BRIEF DESCRIPTION OF THE DRAWINGS

The present disclosure, in accordance with one or more various examples, is described in detail with reference to the following figures. The figures are provided for purposes of illustration only and merely depict typical or example examples.

FIG. 1A illustrates an example HPCaaS system, in accordance with one or more examples described herein.

FIG. 1B is an example computing component that may be used to implement various features of examples described in the present disclosure.

FIG. 2 illustrates an example EQ rating during runtime scenario.

FIG. 3 illustrates an example EQ rating during runtime scenario.

FIG. 4 illustrates an example EQ rating during runtime scenario.

FIG. 5 illustrates an example of extrapolated EQ rating during runtime scenario.

FIG. 6 is a flow chart illustrating example operations that can be performed to determine what EQ rating to use in accordance with examples described in the present disclosure.

FIG. 7 illustrates an example multi-phase workflow scenario.

FIG. 8 depicts a block diagram of an example computer system in which various of the examples described herein may be implemented.

The figures are not exhaustive and do not limit the present disclosure to the precise form disclosed.

### DETAILED DESCRIPTION

As alluded to above, HPC users typically have access to platforms of varying resources, such as servers with different processor types and speed, different interconnection networks, and with or without virtualization. The platforms may also have different charging rates and models, with some freely available and others charging the user(s) for compute capacity per hour. In addition, as platforms are moving into a world of hybrid clouds and deployments, a part of the computing resources may be under a user's control and another part may be in the cloud.

Cloud providers frequently lease computing resources from data centers to re-lease to their clients. Data centers are facilities housing large numbers of computing resources that can be used for storage, processing, switching, and other computing, functions. A data center might lease computing resources to a number of cloud providers who may be called “tenants” in this context. Thus, while a cloud provider might have a number of clients, a data center might have a number of tenants. Various kinds of cloud computing may be categorized as “Platform as a Service” (“PaaS”), “Service as a Service” (“SaaS”), and/or “Infrastructure as a Service” (“IaaS”). As will be described in greater detail below, HPC itself may be implemented as a service (HPCaaS).

With many HPC systems being multi-tenant or multi-user, there is increased difficulty in predicting how each process or workload of an HPC application, for example, affects other processes or how long a process might take to execute. This difficulty in predicting the outcome of any given workload at any given time can lead to poor system utilization since true application performance can only be guaranteed in single-user/single process environments, where no competing processes/users exist. And, multi-tenant environments for HPC can be very expensive for single workloads, and queue times for new workloads can be unacceptable for high priority workloads.

Accordingly, various examples disclosed herein are directed to systems and methods for generating or creating a predictive efficiency-Quality of Service (EQ) model. In some examples, such EQ modeling may comprise or result in a value or metric comprising a predicted customer's pricing level (paid-for Quality of Service (QoS)), a predicted process' workload model, and predicted resources expected to be used by a process (efficiency) for an HPC workload. As used herein, QoS can refer to one or more performance characteristics associated with resource provisioning, e.g., accessibility, throughput, reaction time, security, dependability, and so on. As used herein, efficiency can refer to the amount of resources and time used to complete a task or workload. Efficiency may encompass metrics such as time, energy, and dedicated resources (computing, memory, etc.). It should be noted that an assumption may be made whereby the less energy/time/dedicated resources used to complete a workload or task, the more efficient that workload or task may be. Examples are also directed to predicting workload/process resource needs associated with the initial deployment of an application or solution using the predictive EQ model. Further still, examples are directed to providing runtime-sustained QoS in multi-tenant environments via dynamic assignment or reassignment of resources based on the predictions of the EQ model. Examples of the disclosed technology may also be applied to computing/processing systems in general, e.g., cloud computing, multi-user, and single-user multi-process environments to manage/schedule most any type of computational process/processing operation.

Technical improvements are realized throughout the disclosure. For example, the disclosed technology can improve conventional HPC systems operative in the multi-tenant or multi-user context. That is, problems with conventional HPC system implementations or deployments can include, e.g., difficulty in correlating an achieved or realized QoS with efficiency in using service provisioning (which can be addressed vis-à-vis the disclosed use of an EQ model to predict workload resource needs). Other problems with conventional HPC system implementations or deployments can include difficulties with maximizing efficiency of HPCaaS infrastructure versus maximizing efficiency in a traditional cloud environment (addressed in some examples, by committing resources to achieve a paid-for QoS).

Thus, sustainable QoS for multi-tenant workloads, more efficient billing, and predictive scheduling may be provided in accordance with various examples to address such problems. It should be noted that the EQ model disclosed herein can also be used for advisory services when assigning or selecting HPC resources for any workload. A QoS rating can be periodically recalculated during runtime of an application/service to initially deploy workloads, and add/remove resources as needed to guarantee paid-for QoS while maximizing resource efficiency. Such a QoS rating can based on workload, dataset for training an EQ model, and predicted or estimated runtime of an application or solution.

Conventional or typical HPC systems, unlike examples of the disclosed technology do not have mechanisms to calculate or monitor QoS and efficiency, which in turn make it impossible (or at least very difficult) to guarantee multi-tenant QoS. Instead, best efforts are made to maintain QoS of workloads by either over-provisioning resources to a given workload, or implementing a best-effort strategy with statically-set job priority within the HPC job scheduler. Static QoS settings can be applied today to HPC systems. However, if an already-running job's fixed QoS or priority changes, the job is cancelled and rescheduled with the new QoS or priority. As a result, a determination cannot be made regarding whether or not this rescheduling process has resulted in a more efficient process without the ability to calculate and monitor for efficiency and QoS. Furthermore, such conventional HPC systems do not estimate runtime or workload completion, let alone determine a difference between hardware-based QoS and workload EQ. Modelling EQ of a workload may also be useful, not only within HPC or multi-tenant environments, but also when applied to cloud computing in general, as well as multi-user, and single user multi-process environments to manage and schedule any type of computational process, and may further result in more accurate billing regarding workloads, for example.

Other advantages realized by various examples of the disclosed technology include advantages over conventional HPC systems that focus on only one of either efficiency or “static” QoS that is pre-determined or fixed before application runtime. Instead, some disclosed examples consider both efficiency and QoS in conjunction/together, and operate to maximize both considerations. Disclosed examples also improve upon HPC systems that achieve only coarse-grained agreement on QoS via the long-term dedicated allocation of resources in light of various examples' ability to dynamically assess/reassess and assign/reassign resources. Further still, disclosed examples improve upon conventional HPC systems that attempt to maintain QoS and efficiency, but only in a best-effort manner. For example, best efforts to maintain a given/desired QoS may include over-provisioning resources to increase the probability that the given/desired QoS will be met (albeit without any guarantee of meeting the given/desired QoS). Again, such problems can be addressed or at least mitigated by dynamically reassigning resources depending on workload needs that are assessed/reassessed during runtime.

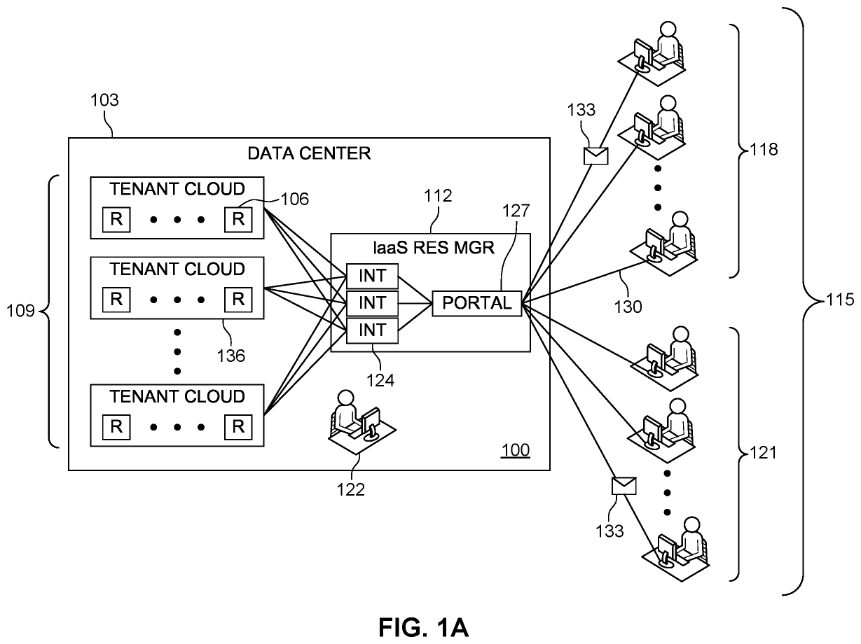

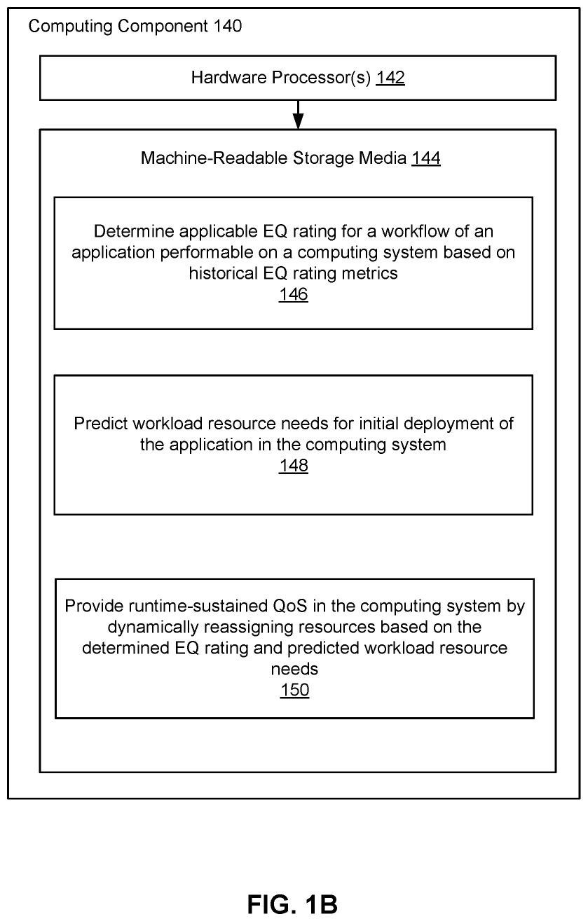

FIG. 1A depicts a high-performance computing environment and users thereof in accordance with one or more examples. More particularly, FIG. 1A depicts an HPC environment 100 housed in a data center 103. The data center 103 provides at least three types of services: Information technology (“IT”) Infrastructure Services, Application Services, and Business Services. IT Infrastructure Services include Data Center Local Area Network (“DC LAN”), firewalling, load balancing, etc. IT Infrastructure Services may not be perceived by business users as being part of IT operations. Application Services include network-based services, network-enabled services, mobile services, unified communications and collaboration (“UC&C”) services, etc. Application Services are accessible by business users. Business Services include Business Intelligence, vertical applications, Industry applications, etc. With Business Services, the network enables access and data transportation, including possible security performance, isolation, etc.

Services such as the above may be implemented, as in examples described herein, in a data center network, for example, as data center service-oriented networking. Such a data center network has a networking infrastructure including computing resources, e.g., core switches, firewalls, load balancers, routers, and distribution and access switches, etc., along with any hardware and software required to operate the same. Some or all of the networking services may be implemented from a location remote from the end-user and delivered from the remote location to the end-user. Data center service-oriented networking may provide for a flexible environment by providing networking capabilities to devices in the form of resource pools with related service attributes. Service costs may be charged as predefined units with the attributes used as predefined.

The HPC environment 100 includes a plurality of computing resources (“R”) 106 (only one indicated) from which a plurality of tenant clouds 109 are organized. The computing resources 106 may include, for instance, services, applications, processing resources, storage resources, etc. The tenant clouds 109 may be either public or private clouds depending on the preference of the tenant 118 to whom the tenant cloud 109 belongs.

The number of tenant clouds 109 can vary. Although the HPC environment 100 in this example is shown including only cloud computing systems (i.e., the tenant clouds 109), the subject matter claimed below is not so limited. Other examples may include other types of computing systems, such as enterprise computing systems (not shown). The tenant clouds 109 may be “hybrid clouds” and the HPC environment 100 may be a “hybrid cloud environment.” A hybrid cloud is a cloud with the ability to access resources from different sources and present as a homogenous element to the cloud user's services.

Also shown in FIG. 1A are a plurality of cloud users 115. The cloud users 115 include tenants 118 and clients 121. The tenants 118 lease the computing resources 106 from the proprietor of the data center 103, also sometimes called the “provider.” The tenants 118 then organize the leased computing resources 106 into a tenant cloud 109. The tenant cloud 109 includes, for instance, hardware and services that a client 121 can use upon payment of a fee to a tenant 118.

This arrangement is advantageous for all three of the provider 122, the tenant 118, and the client 121. For example, the client 121 uses, and pays for only those services and other resources that they need. For example, the tenant cloud 109 of the tenant 118 is readily scalable if clients 121 of tenant 118 need more or fewer computing resources 106 than tenant cloud 109 needs to meet the computing demands of clients 121. As another example, the data center 103 does not have to worry about the licensing of services and software to clients 121 but still commercially exploits its computing resources.

HPC computing environment 100 also includes an IaaS resource manager 112. The IaaS resource manager 112 may include a plurality of IaaS system interfaces 124 (only one indicated) and a resource auditing portal 127. The specifics of what kind of IaaS system interfaces 124 are used will be implementation specific depending on context. For example, IaaS system interfaces may include, but are not limited to, an Application Program Interface (API), a Command Line Interface (CLI), and a Graphical User Interface (GUI). In some examples, the Iaas resource manager 112 may include other types of interfaces in addition to, or in lieu of the above-identified interfaces. The number and type of IaaS system interfaces 124 will depend on the technical specifications of the tenant clouds 109 in a manner that will be apparent to those skilled in the art having the benefit of the present disclosure.

IaaS resource manager 112, may comprise a software component that initiates reconfiguration of system resources (e.g., processors, memory, storage, etc.) by instructing an operating system plugin to do so, and/or lower layers (by instructing a fabric manager, for example, (not shown)). IaaS resource manager 112 may act based on specified policies provided by a system administrator. IaaS resource manager 112 may measure CPU, memory, storage, and network usage and traffic data. IaaS resource manager 112 may decide when to switch resource configurations (e.g., memory, processor, etc.) for particular software applications (e.g., to improve image processing, to improve user experience, etc.).

Portals such as the resource auditing portal 127 are industry methodologies allowing cloud users 115 to interact with the IaaS system interfaces 124. It should be understood that PaaS, SaaS, and IaaS may be conceptualized as “layers” of (e.g., cloud) computing because they are typically exploited by different classes of computing resource users. SaaS may be considered the top layer and is the type of computing with which most users interact with a cloud. PaaS may be considered the middle layer, and is used by, for instance, web developers, programmers and coders to create applications, programs, software and web tools. IaaS is the bottom layer and includes the hardware, network equipment and web hosting servers that web hosting companies rent out to users of PaaS and SaaS. More particularly, IaaS includes physical computing hardware (servers, nodes, PDU's, blades, hypervisors, cooling gear, etc.) stored in a data center operated by network architects, network engineers and web hosting professionals/companies.

In operation, a cloud user 115 is typically located remotely to, or off the premises of, the data center 103. The cloud user 115 interacts over a secure link 130 (only one indicated) with the IaaS system interfaces 124 through the resource auditing portal 127 to perform a cloud task relative to a particular one of the tenant clouds 109 of the HPC environment 100. The nature of the cloud task forms a part of the context just mentioned and will also be discussed further below in connection with one particular example.

The links 130 may be one or more of cable, wireless, fiber optic, or remote connections via a telecommunication link, an infrared link, a radio frequency link, or any other connectors or systems that provide electronic communication. Links 130 may include, at least in part, an intranet, the Internet, or a combination of both. The links 130 may also include intermediate proxies, routers, switches, load balancers, and the like.

FIG. 1B illustrates an example computing component that may be used to implement runtime-sustained QoS and optimized resource efficiency. Referring now to FIG. 1B, computing component 140 may be, for example, a server computer, a controller, or any other similar computing component capable of processing data. In the example implementation of FIG. 1B, the computing component 140 includes a hardware processor(s) 142, and machine-readable storage medium 144.

Hardware processor(s) 142 may be one or more central processing units (CPUs), semiconductor-based microprocessors, and/or other hardware devices suitable for retrieval and execution of instructions stored in machine-readable storage medium 604. Hardware processor(s) 142 may fetch, decode, and execute instructions, such as instructions 146-150, to control processes or operations for implementing the dynamically modular and customizable computing systems. As an alternative or in addition to retrieving and executing instructions, hardware processor(s) 142 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 144, may be any electronic, magnetic, optical, or other physical storage device that contains or stores executable instructions. Thus, machine-readable storage medium 144 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 144 may be a non-transitory storage medium, where the term “non-transitory” does not encompass transitory propagating signals. As described in detail below, machine-readable storage medium 144 may be encoded with executable instructions, for example, instructions 146-150.

As alluded to above, examples of the disclosed technology provide EQ modelling that can be used to determine/predict resource scheduling in an HPC system, as well as for advisory services, i.e., services that can be used to assign/select particular HPC resources to support a particular workload(s). Thus, hardware processor 142 may execute instruction 146 to determine an applicable EQ rating for a workflow of an application performable on a computing or processing system, e.g., an HPCaaS system, based on historical EQ rating metrics. In particular, a QoS rating can be determined, where the QoS rating characterizes an overall HPC system as well as particular, individual workloads. It should be understood that the overall HPC system QoS rating can refer to the total available QoS possible for a given system, independent of individual workloads with a runtime QoS rating. The amount of available overall system QoS can be affected by the amount of workloads running, and each respective workload's QoS requirements which is to be maintained during runtime. On the other hand, QoS ratings regarding individual workloads can refer to the amount of available system resources and QoS (during runtime) being used at a given time by a running workload on the system.

As used herein, the term QoS rating, can refer to some value or similar representation of the level of service paid for by a user/tenant/client being obtained, in real-time. That is, QoS can be a constantly-calculated value (e.g., an average of previous values, a lowest/highest obtained value, or other similar/derivative value(s) as recalculated throughout the workload lifecycle. The runtime QoS rating can be determined while a computing system is operational/while a workload is operational, and can be used as a basis for determining appropriate billing (to a user/customer of the computing system) depending on specified and realized QoS in a multi- (or single-) tenant environment. Because QoS is not static, but rather dynamic/updatable in real-time, more accurate billing associated with resource usage, for example, or experienced/realized QoS, can be achieved. Advisory QoS services can also be provided before workload or application runtime. In this way, based on the EQ modeling performed, billing and scheduling of computing resources/processes can be accomplished in a manner that matches or is able to achieve a given runtime QoS rating.

In some examples, EQ modeling can be achieved by monitoring or metering QoS and resource usage of applications during runtime to create a (historical) time-series set(s) of data. This time-series data can be used to train a predictive EQ algorithm to create/derive a machine learning model that can predict a value or other information or data reflecting a customer's paid-for QoS level, a process'/application's workload model (i.e., what/to what extent or how much computing system resources are needed, and when or for how long such computing system resources are needed), as well as resource efficiency. Again, as noted previously, examples of the disclosed technology consider both, resource efficiency and QoS, and seek to maximize/optimize both factors. Historical metrics (i.e., the time-series set(s) of data) can also be used in the context of advisory services to encourage better efficiency with regard to resource usage, resource planning, and recommendations for increasing application QoS. That is, the relationship between QoS and efficiency reflected in runtime QoS rating can be extrapolated using machine learning/linear regression techniques.

Hardware processor 142 may execute operation 148 to predict workload resource needs for the initial deployment of the application in the computing system. Again, initial deployment of a service or application can be based on paid-for QoS, which may include multi-dimensional and multi-phase guarantees regarding QoS. For example, a desired QoS regarding a particular workflow may vary depending on the progress of that particular workflow, e.g., certain processes performed at the outset of a workflow may require different QoS than processes performed later on in the lifetime of the workflow. Likewise, desired QoS may vary relative to multi-dimensional workloads, e.g., where a workload may comprise multiple applications, one or more or which may demand a particular QoS. In some examples, described in greater detail below, paid-for QoS may be considered in light of historical/estimated workload resource usage to determine expected required resources. Alternatively, an EQ rating, as predicted via EQ modeling, or based on workload/job similarity to historical workloads/jobs, can be used as a fixed QoS setting that can be maintained via appropriate resource assignment. The predicted workload resource needs may be further based on expected required resources (reflected as efficiency herein), where again, resources may be shared by multiple users/customers, e.g., in a multi-tenant environment.

Hardware processor 142 may execute operation 150 to provide runtime-sustained QoS in the computing system by dynamically reassigning resources based on the determined EQ rating and predicted workload resource needs. Some examples achieve this runtime-sustained QoS by tracking runtime metrics of an application's QoS and resource usage, and adjusting resource usage/allocation accordingly. In some examples an average or mean QoS can be tracked and used as a basis for ensuring, overall, that the mean QoS comports with a paid-for QoS. Alternatively still, dynamic reassignment may be effectuated by offering discounts to users/customers when an average QoS associated with a workload, for example, does not meet a paid-for QoS. In this way, the average QoS rating will in fact comport with/match the paid-for QoS, payment wise.

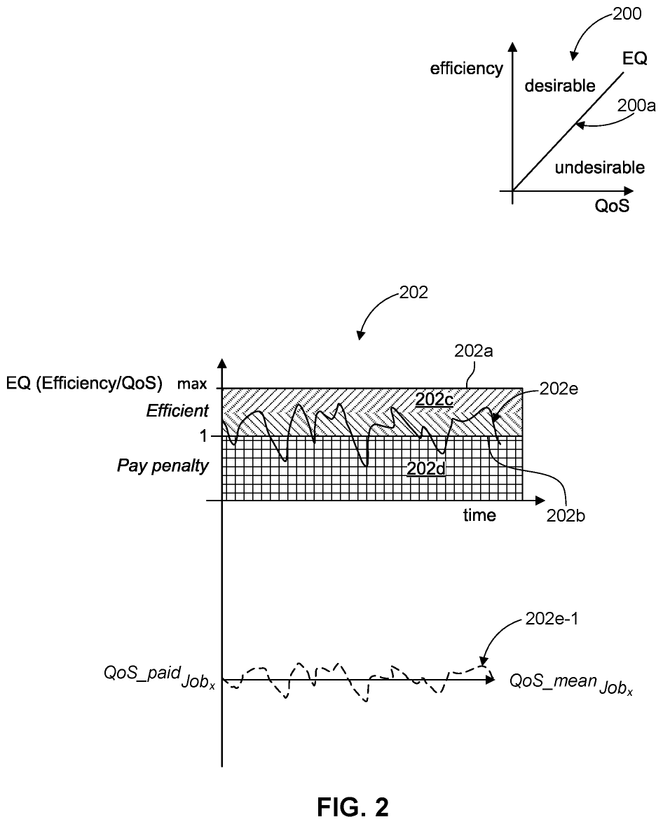

Referring now to FIG. 2, a graphical representation 202 of EQ and QoS as a function of time is provided. It should be understood that “legend” 200 illustrates the relationship between efficiency and QoS as considered by examples of the present disclosure. The line 200a representative of an EQ rating or value reflects a simplified delineation between desirable EQ (i.e., good/high efficiency regarding resource scheduling, assignment, or use, as well as good/desired QoS level) and undesirable EQ (i.e., inefficient resource usage and less than desirable/paid-for QoS).

Graphical representation 202 illustrates EQ rating as a function of time. A maximum EQ rating 202a is illustrated along with a given (e.g., paid-for) QoS threshold 202b that define a zone of efficiency 202c and a pay penalty zone 202d. Line 202e represents a current workload EQ rating relative to the zones of efficiency and pay penalty 202c and 202d, respectively. As can be appreciated when the EQ rating is in the zone of efficiency and above the QoS threshold 202b, the current EQ rating falls within the desirable EQ rating range vis-à-vis legend 200. However, if efficiency or QoS falls below (or outside) the QoS threshold 202b, the corresponding EQ rating suggests that one of either a service provider or customer should pay some penalty. That is, a provider may pay a penalty for failing to provide an agreed upon/paid-for level of QoS corresponding to a particular user or customer. That is, a provider may, in response to such an EQ rating, offer a discount or offer some partial refund to a customer if the desired QoS is not achieved. Alternatively, it may be that the user or customer pays a penalty due to their paid-for QoS not being sufficient to accommodate the user's/customer's desired QoS. For example, a customer's use/consumption of resources ultimately exceeds what was originally agreed to/paid for, in which case, the customer may be made to remit further/additional payment to account for this disparity in actual vs anticipated resource usage. It should be understood that the described payment would occur pursuant to application of various examples to determine the EQ rating of, e.g., a workload. Moreover, it can be appreciated that graphical representation 202 reflects the aforementioned aspect of some examples, whereby efficiency and QoS are factors that are considered together (not merely one or the other), and at the same time or simultaneously relative to a given time/time period. Again, conventional HPC systems do not account for both efficiency and QoS, let alone at the same time. It should be noted that efficiency impacts or favors the service provider or HPC system, whereas QoS impacts or favors the user or customer. Thus, examples of the disclosed technology are able to optimize operation from both the service provider and the customer perspectives.

Below is an example algorithm that can be used in some examples to manage EQ and guarantee some level of QoS if a current EQ rating falls into an undesirable range of values. That is, if, for example, the average QoS of a job or workload (QoS_mean_{JobX}), illustrated as line 202e-1, is less than a paid-for QoS for that job/workload, the service provider should, e.g., pay a penalty for not providing the requisite QoS level to the customer. Returning to the example algorithm, if the average QoS of a job or workload (QoS_mean_{JobX}) exceeds the paid-for QoS (QoS_paid_{JobX}), QoS value/rating is decremented, or otherwise, incremented when average QoS is less than the paid-for QoS. Thus, the average QoS rating/value can be consistently updated based on the recalculated QoS during runtime, since the average QoS can be higher or lower than the paid-for QoS. The consistent updating is performed to match the paid-for QoS during operation. Moreover, in this example scenario, efficiency may be variable, whereas QoS is fixed. It should be understood that either efficiency or QoS can be prioritized. If QoS is prioritized, efforts to improve/maintain QoS will be made at the cost of efficiency, e.g., by adding/removing system resources, energy, or time, for example, any/some/all of which can impact efficiency, positively and negatively. If, on the other hand, efficiency is prioritized over QoS, changes to QoS can be made to optimize efficiency. Moreover, if QoS or efficiency are not able to be maintained, discounts or penalties can be paid to compensate for lack of desired QoS or efficiency.
if (QoS_mean_{JobX}<QoS_paid_{JobX}){QoS++}
elseif (QoS_mean_{JobX}>QoS_paid_{JobX}){QoS−−}

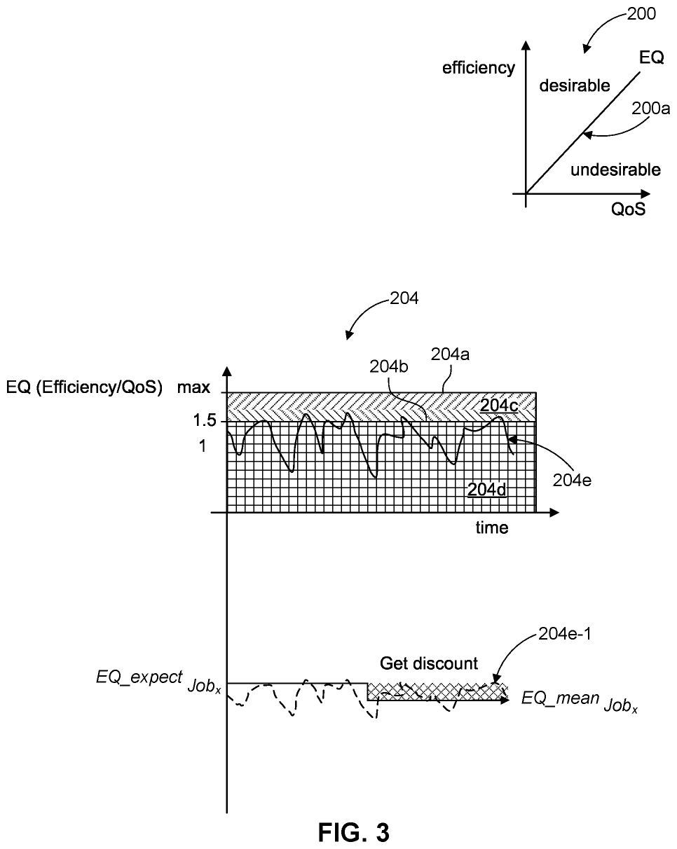

FIG. 3 provides another graphical representation 204 of EQ and QoS as a function of time. Graphical representation 204 illustrates EQ rating as a function of time. A maximum EQ rating 204a is illustrated along with a given (e.g., paid-for) QoS threshold 204b that define a zone of efficiency 204c and a pay penalty zone 204d. Line 204e represents a current workload EQ rating relative to the zones of efficiency and pay penalty 204c and 204d, respectively. As can be appreciated when the EQ rating is in the zone of efficiency and above the QoS threshold 204b, the current EQ rating falls within the desirable EQ rating range vis-à-vis legend 200. However, if efficiency or QoS falls below (or outside) the QoS threshold 204b, the corresponding EQ rating suggests that one of either a service provider or customer should pay some penalty. In this example, it can be appreciated that the EQ rating represented by line 204e suggests a need to renegotiate QoS. That is, the EQ rating falls at or outside of the QoS threshold 204b the majority of the measured time period, in which case, a service provider may need to pay a penalty for not providing the customer with the agreed/paid-for QoS. Payment of a penalty by a service provider may be effectuated vis-à-vis the granting of a discount to the customer, for example. Average EQ is represented in FIG. 3 by line 204e-1 and illustrates that during a portion of the measuring period, the average EQ rating fell below the expected EQ rating.

Below is an example algorithm that can be used in some examples to manage EQ and guarantee some level of QoS if a current EQ rating falls into an undesirable range of values. In other words, if the average EQ rating is less that the expected EQ rating, the paid-for QoS can be decreased/decremented accordingly.
if (EQ_mean_{JobX}<EQ_expect_{Jobx}){QoS_paid−−}

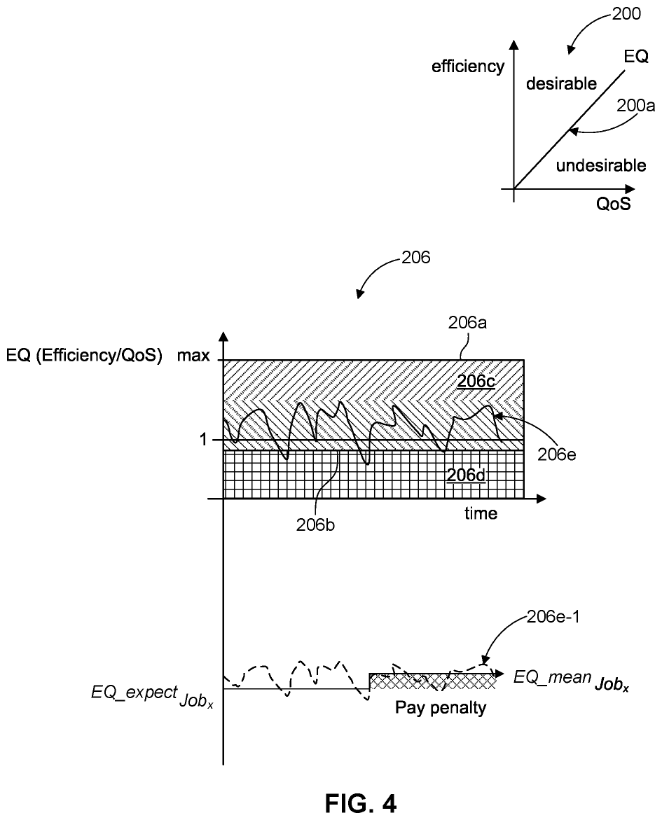

FIG. 4 provides yet another graphical representation 206 of EQ and QoS as a function of time. Graphical representation 206 illustrates EQ rating as a function of time. A maximum EQ rating 206a is illustrated along with a given (e.g., paid-for) QoS threshold 206b that define a zone of efficiency 206c and a pay penalty zone 206d. Line 206e represents a current workload EQ rating relative to the zones of efficiency and pay penalty 206c and 206d, respectively. As can be appreciated when the EQ rating is in the zone of efficiency and above the QoS threshold 206b, the current EQ rating falls within the desirable EQ rating range vis-à-vis legend 200. However, if efficiency or QoS falls below (or outside) the QoS threshold 206b, the corresponding EQ rating suggests that one of either a service provider or customer should pay some penalty. In this example, it can be appreciated that the efficiency may be the focus of a customer (over QoS), it may be advantageous for the customer to realize some more flexibility regarding QoS, in which case, the service provider may pay a penalty back to the customer (in terms of providing additional resources to the customer to increase efficiency).

Below is an example algorithm that can be used in some examples to manage EQ and guarantee some level of QoS if a current EQ rating exceeds an expected EQ range of values. Thus, if the average EQ rating (represented by line 206e-1) exceeds the expected EQ rating, the paid-for QoS can be increased/incremented, again so as to match paid-for EQ/average EQ ratings.
if (EQ_meanJobX>EQ_expectjobX){QoS_paid++
else {nop}

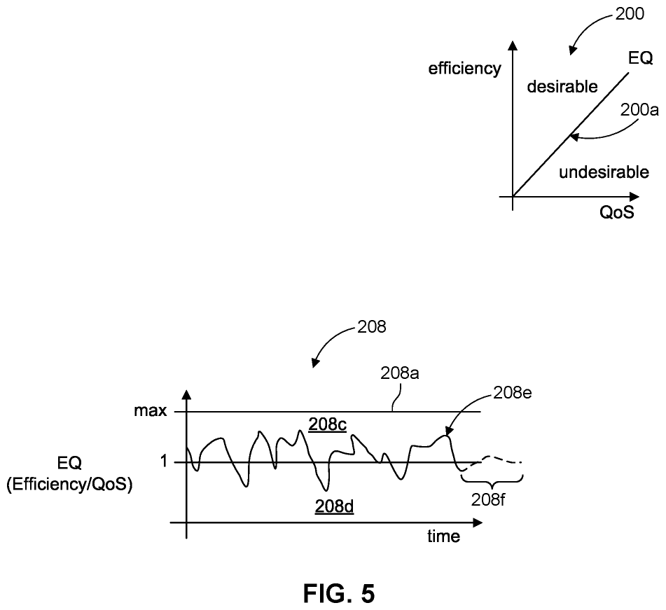

FIG. 5 illustrates an example of calculating an EQ ratio in accordance with the above-described scenario. As with previously-described FIGS. 2-4, FIG. 5 provides yet another graphical representation 208 of EQ and QoS as a function of time. Graphical representation 208 illustrates EQ rating as a function of time. A maximum EQ rating 208a is illustrated along with a given (e.g., paid-for) QoS threshold 208b that define a zone of efficiency 208c and a pay penalty zone 208d. Line 208e represents a current workload EQ rating that has been determined based on metering/monitoring the current workload of an operational application or service. The section of line 208e labeled 208f reflects a predicted EQ rating based on the results of predictive EQ modeling and extrapolating an EQ rating for some subsequent amount of time/time period following the time during which the historical metrics were obtained. That is, and again, EQ modeling can be achieved by monitoring or metering QoS and resource usage of applications during runtime to create a (historical) time-series set(s) of data. This time-series data can be used to train a predictive EQ model to predict a value or other information or data reflecting a customer's paid-for QoS level, a process'/application's workload model, as well as resource efficiency.

More particularly, machine learning-based time-series data forecasting may be used to predict EQ rating based on historical EQ ratings as illustrated in FIG. 5. Efficiency can be defined as how efficient a workload uses a given resource. It can be determined by the amount and type of resources used. Resource type can be a weighted metric based on energy consumption and performance of any given resource. QoS can be defined as a metric made up of dataset metadata (size, hyperparameters, and locations), computational complexity (algorithm, compilation, build, configuration parameters, libraries, user space configuration), which in turn is a function of computational complexity of a given workload, which can be combined with a paid-for level or amount of QoS. Relevant formulas for predicting EQ are as follows.

EQ_{process_y time=t+1}=f(averageEQ_{process_y},trendEQ_{process_y},seasonalityEQ_{process_y}, noise_{process_y})

EQ_{process_y time=t}=(efficiency_{mean_process_y}/qos_{mean_process_y})timeₜ

efficiency_meanprocessy=Σₜ₌₀^{t=N}efficiency_{process_y_time=t}/N

efficiencyprocessy time=t=ResourceUsageₜᵢₘₑ₌ₜ×ResourceType

qos_meanprocessy=Σₜ₌₀^{t=N}qos_{process_y_time=t}/N

qos_{process_y time=t}=f(dataset_metadata_{y},computational_complexity_{y time=t})×PaidForQoS

EQ relative to a process y at some time is defined as a function of average EQ for that process, EQ trend for that process, EQ seasonality for that process (characteristics of a process, such as amount of use, can vary depending on season/timing), and any noise that may be detected for that process. The EQ rating for a process at some time t, equates to average/mean efficiency divided by average/mean QoS multiplied by the relevant time. Average or mean efficiency can equate to the sum of a process' efficiency at some time t divided by the number of efficiency samples/measurements taken, whereas efficiency itself for some process at some time equates to resource usage at some time t times the type of resource at issue. Average or mean QoS may equate to the sum of QoS ratings for a process over some time period divided by the number of times during that time period when QoS rating is determined. QoS for a particular process at some time t may be a function of a dataset's metadata, computational complexity times a paid-for QoS.

As noted above, linear regression methods or algorithms may be used to predict EQ rating based on historical EQ ratings, again, as reflected in FIG. 5, where the following equations apply.

EQ_{process_y time=t}=(efficiency_{mean_process_y}/qos_{mean_process_y})timeₜ

EQ_{process_y time=t+1}=B0+B1×EQ_{process_y time=t}

B0=coefficient_{bias}, B1=coefficient_{EQ}

In some examples, an EQ rating may be reflected as an EQ ratio that is derived by comparing either dataset metadata or algorithm computational complexity against the aforementioned historical metrics or predicted EQ ratings. Computational complexity, as used herein, can refer to those algorithms comprising or representing the application or workload in which the efficiency-QoS rating is being calculated, and against which, QoS is being maintained. Since some HPC workloads are more or less complex than others, HPC workloads might require different resources, time, or energy to complete, and thus have a different efficiency and possibly QoS capability than other workloads. Computational complexity can include various factors, parameters, etc., that can impact complexity, e.g., number of inputs, outputs, and internal algorithms used to solve the problem (for example using addition compared to multiplier algorithms within the workload to reach the same result). Instead of predicting by extrapolation, in some examples, a comparable/similar EQ rating can be assigned as a currently running workload's EQ rating if either dataset metadata, an algorithm's computational complexity, or both are similar to a previously running workload's dataset or algorithm computational complexity.

It should be noted that in some examples, the predicted EQ rating obtained by using a predictive EQ model as described above can be used to verify that the EQ rating/ratio derived from comparing the dataset or algorithm computational complexity against historical workload EQ ratings, and vice versa. That is, the disclosed methods of obtaining an applicable EQ rating need not be mutually exclusive in use.

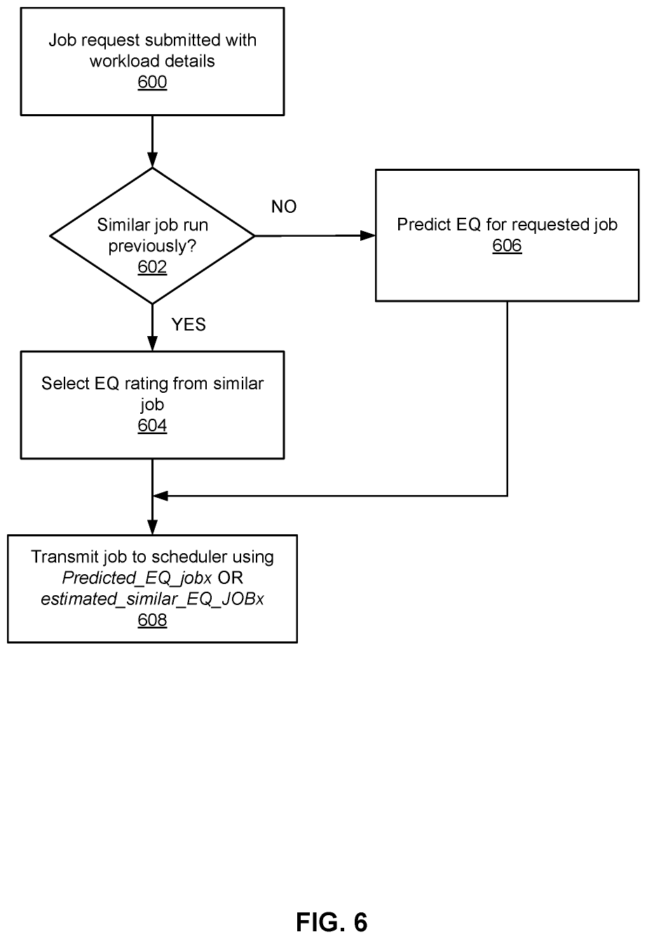

FIG. 6 illustrates example operations that may be performed for utilizing either a predicted EQ rating or one with job similarity. As described in accordance with other examples above, a user may wish to run an application(s) or perform some process(es), where the application/process leverages various resources, e.g., in the cloud, and where a corresponding workload (to be put onto the resources) is associated with the running of the application. It should be understood that a workload can be made up of a plurality of jobs, i.e., jobs may be considered to be subsets or sub-aspects of a workload. For example, if some workload comprises outputting some result based on input data, one job may comprise accessing the input data from a federated data repository, another job may comprise analyzing that input data and making some prediction thereon, while yet another job may comprise the act of outputting the result to a requestor.

Accordingly, at operation 600, a user or customer may submit a request to perform some job along with workload details corresponding to that job. Workloads may have certain characteristics, e.g., data transmission rates, associated error rates, etc. Workloads may also correspond with a location, including a local workload (e.g., within a local resource domain) or a system-wide workload (e.g., across multiple resource domains or crossing multiple data centers, for example). In some examples, the workload may be defined by a pattern, e.g., latency in data transmissions can occur repeatedly in a pattern. In another example, some defined range contention (associated with a workload), e.g., relating to access to a memory range from different nodes, may be a factor that is considered in a potential reconfiguration/reassignment of resources from a standard-scale memory to large-scale shared memory. In still other examples, the workload may be defined by geographic characteristics, time patterns, certain sets of operating characteristics, and so on.

At operation 602, a check may be performed to determine whether a similar job has been run by the HPCaaS system. As discussed above, jobs may be considered to be subsets or sub-aspects of a workload, and may comprise workload-related operations such as accessing the input data from a federated data repository, analyzing input data and making some prediction thereon, outputting a result to a requestor, and so on. Thus, job similarity can refer to aspects, characteristics, or parameters associated with or related to the performance or configuration of a job that are similar or common between multiple jobs. For example, job similarity may occur when two or more jobs involve accessing the same memory and compute resources, or when two or more jobs require some prerequisite output from another job(s) before the two or more jobs are able to progress with their respective compute operations. Job similarity can be derived by comparing historical workload details with metadata from a current workload. This metadata can include details regarding dataset (size, hyperparameters, and locations), and computational complexity (algorithm, compilation, build, configuration parameters, libraries, user space configuration that may impact the amount or level of computational power/resources needed). If a similar job is identified by a matching dataset and/or computational complexity, then the EQ rating from/associated with the historical workload details may be used in lieu of a new predicted EQ rating (obtained by executing the aforementioned predictive EQ model).

That is, at operation 604, the EQ rating from the identified similar job(s) is selected for use. As will be described in greater detail below, use of the EQ rating in this context, may comprise use as a baseline or threshold efficiency/QoS value(s) or rating against which tracked runtime metrics of the application and resource usage may be compared. As discussed above, in relation to, e.g., FIGS. 2-4, examples of the disclosed technology may adjust EQ depending on certain customer-desired EQ/QoS or EQ-QoS-related considerations.

However and to the above, if a similar job cannot be found as having been previously run on the HPCaaS system, a predicted EQ rating obtained by executing the aforementioned predictive EQ model, can be used at operation 606. As described above, predictive EQ modeling can be achieved by monitoring or metering QoS and resource usage of applications during runtime to create a time-series set(s) of data. This time-series data can be used to train a predictive EQ model to predict a value or other information/data reflecting a customer's paid-for QoS level, a process'/application's workload model, as well as resource efficiency, e.g., using, machine learning-based time-series data forecasting. Again, efficiency can be defined as how efficient a workload uses a given resource, determinable by the amount and type of resources used, while QoS can be defined as a metric made up of dataset metadata (size, hyperparameters, and locations), computational complexity (algorithm, compilation, build, configuration parameters, libraries, user space configuration), which can be combined with a paid-for level or amount of QoS. Machine learning methods, such as linear regression methods may be used to predict EQ rating based on historical EQ ratings.

At operation 608, the job requested to be performed by the user may be transmitted to a scheduler using either the predicted EQ rating associated with the job (recalling that multiple jobs make up a workload) or an estimated EQ rating that is similar to a previous job(s). Thus, initial deployment of an application and its associated workflow/jobs may be effectuated using the appropriate EQ rating. As execution of the application progresses, as described herein, efficiency or QoS may be adjusted/adapted to comport with the desired/necessary QoS and efficiency. That is, the QoS and resource usage can be monitored as the application executes, allowing for updating of the aforementioned time-series set(s) of data to occur during application execution. In turn, predicted EQ ratings can be calculated/updated accordingly. In this way, resources can, for example, be dynamically reassigned, and runtime-sustained QoS can be achieved based on the determined EQ rating and predicted workload resource needs during application execution/workflow performance.

In particular, and regarding initial deployment of an application, such initial deployment of the application is based on paid-for QoS, desired efficiency, and resource considerations given a multi-tenant environment (if multi-tenancy is a relevant factor). In some examples, predicting workload resource needs to accommodate an initial application deployment can be achieved by combining a paid-for QoS value/information with information regarding historical or estimated workload resource usage at one or more phases of the workflow. Phases of a workflow can be defined or set forth by a user, network administrator, or in some examples, may be a function of the workflow itself, e.g., based on accessing or usage of particular resources, types of operations or jobs performed, etc. It should be understood that as used herein, the term workload can refer to the amount of resources used at/during some given time of an application in use, while a workflow (of an application) can refer to the various stages or phases of operations/calculations being performed. Each workflow may have a unique workload. Combining in this context can refer to considering paid-for QoS and workload resource usage as factors, together, e.g., as described above, and illustrated in, e.g., FIGS. 2-4. Multi-phased workflows may then be deployed on an HPCaaS system, in particular, on multi-tenant resources, the use of which has been predicted in a way(s) that guarantee the paid-for QoS for each application in each of its phases.

Alternatively, as alluded to above, a predicted or historically similar EQ rating can be transmitted with requested jobs to a job/runtime scheduler. It should be understood that the entire EQ (efficiency and QoS) or any of its components (efficiency OR QoS) can be re-used in a subsequent process with similar characteristics. If the entire EQ, or efficiency aspect is reused by a future process, then that implies a similar set of resources, time to complete, and energy would be used to schedule the process. If the entirety of an EQ rating/value, or QoS is re-used by a future process, the implication is that the QoS setting would be statically set and maintained, if possible, during program completion. An example of such a scheduler is the Simple Linux Utility for Resource Management (Slurm) workload manager, which can be used for scheduling jobs. For example, using a Slurm workload manager, each running job may be taken into consideration, and determines when every pending job (in priority order) should be started. Factors such as job preemption, gang scheduling, generic resource requirements, etc. may be taken into account when scheduling jobs in a manner that comports with the set QoS. The utilized EQ rating can then be maintained by the job scheduler during job runtime for the assigned resources in the multi-tenant HPCaaS system or environment.

In order to provide runtime-sustained QoS, as alluded to above, examples of the disclosed technology, implemented for example as/in a resource manager, e.g., IaaS resource manager 112 (FIG. 1A), dynamically reassign resources in accordance with multi-dimensional QOS across multiple phases of a workload or application execution (FIGS. 2-4). In accordance with one example, runtime metrics regarding application QoS and resource usage can be tracked and compared to the paid-for QoS and historical or estimated QoS and resource usage. As application execution progresses through its various workflow phases, resources can be added/removed/reassigned as needed to sustain, as closely as possible, the paid-for QoS, for as long as possible throughout job runtime. This process can be repeated as needed for all tenant applications running in an HPCaaS. If a given QoS cannot be sustained, the application/process can be paused or rescheduled for another time/time period that can accommodate a higher runtime QoS.

In accordance with another example, average QoS (QoSₘₑₐₙ) can be tracked during runtime. If the average QoS is less that the paid-for QoS (QoS_paid) for a particular job, the actual QoS for the job can be increased until the next “calculation cycle” during which a new/adjusted EQ rating is determined. If the average QoS exceeds the paid-for QoS for a particular job during runtime, QoS for that job is decreased, again until the next calculation cycle. In this way, the average QoS remains in-line with the paid-for QoS by the time the application/process is done executing, thereby enabling the paid-for QoS to be guaranteed. It should be understood that IaaS resource manager 112 (described above), may control reconfiguration of system resources, and can act based on specified policies provided by a system administrator, such as paid-for-QoS. As also described above, IaaS resource manager 112 may measure CPU, memory, storage, and network usage and traffic data. IaaS resource manager 112 may decide when to switch resource configurations (e.g., memory, processor, etc.) for particular software applications (e.g., to improve image processing, to improve user experience, etc.). By virtue of reconfiguring system resources, desired QoS can be achieved, or can be accounted for (in the event payments/credits are to be made).

In accordance with yet another example, average QoS can be tracked during job runtime. Billing discounts can be offered when the average QoS tracked during job runtime is less than/does not meet the paid-for QoS at the end of execution of a job. Here as well, the re-factored paid-for QoS may then become/be considered a guaranteed QoS that matches the paid-for QoS.

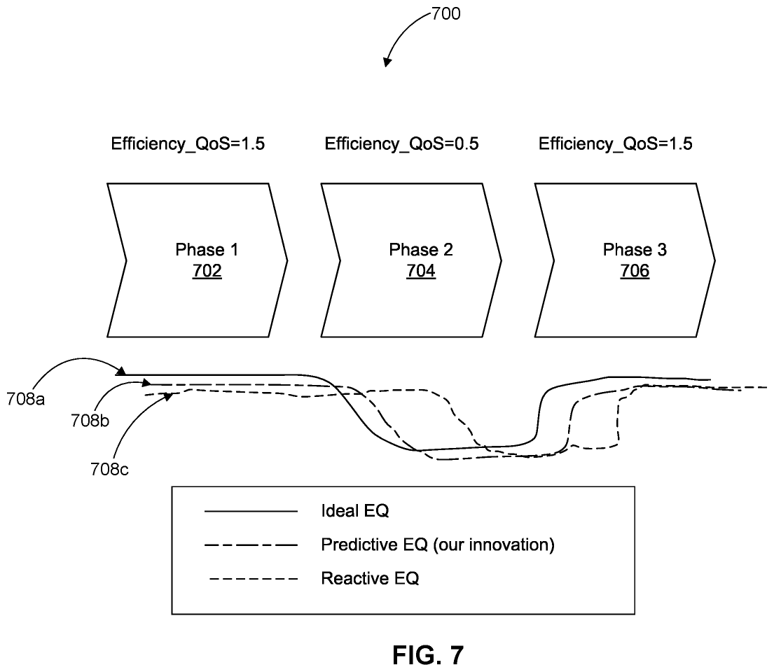

Referring to FIG. 7, an example workflow/workload 700 having three phases (first phase 702, second phase 704, and third phase 706) is illustrated. In this example, an EQ rating of 1.5 is assumed for the first phase 702, 0.5 for the second phase 704, and 1.5 again for the third phase 706. As noted above, this EQ rating value can be one that was predicted using a historical EQ metrics-trained predictive EQ model, or selected as being similar to one associated with a previously-run job(s). An example of an ideal EQ rating as it progresses through the various phases is represented as line 708a. It can be appreciated that the ideal EQ rating tracks the predicted/selected EQ rating per phase, maintaining an EQ rating of 1.5 during the first phase 702, dropping to during the second phase 704, and rising again to 1.5 during the third phase 706. Line 708b reflects an example of a predicted/estimated EQ rating obtained in accordance with various examples of the disclosed technology. Although there is some “latency” present (due to the time needed for calculation cycles/prediction/estimation/etc.) the predictive EQ rating closely tracks that of the ideal EQ rating during runtime. In contrast, as reflected by line 708c, which is an example representation of an EQ rating resulting from conventional HPCaaS system implementations that (as noted above), do not consider efficiency and QoS together, cannot account for multi-tenant scenarios, etc., it can be appreciated that the EQ rating remains at about a value of 1.5 well into the second phase 704 instead of transitioning to a value of about 0.5. Likewise, the EQ rating of 0.5 is maintained well into the third phase 706 despite the ideal EQ rating rising back to a value of 1.5. Indeed, line 708c which can be referred to as a “reactive” EQ reflects a resource manager's inability to sustain a desired/required efficiency and QoS during job runtime.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

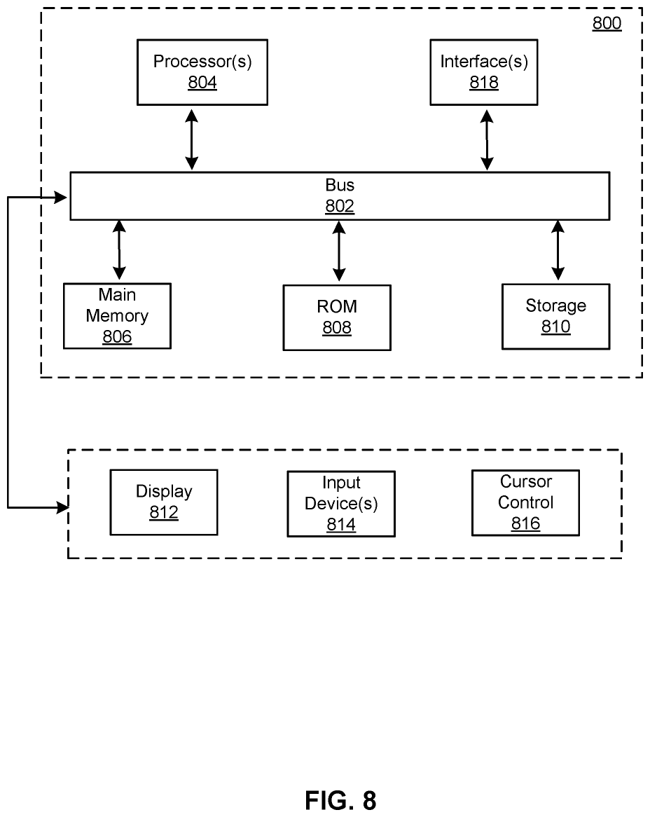

FIG. 8 depicts a block diagram of an example computer system 800 in which various of the examples described herein may be implemented. The computer system 800 includes a bus 802 or other communication mechanism for communicating information, one or more hardware processors 804 coupled with bus 802 for processing information. Hardware processor(s) 804 may be, for example, one or more general purpose microprocessors. Various elements/components of the examples disclosed herein (e.g., IaaS resource manager 112 or data center 100 of FIG. 1A/computing component 140 of FIG. 1B (or components therein), computing or processing components used by cloud users 115 of FIG. 1A) may be an embodiment of/embodied by a computer system, such as computer system 800.

The computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions. For example, machine-readable storage media 144 of FIG. 1B may be an embodiment of main memory 806, where, e.g., instructions 146-150 of FIG. 1B, a predictive EQ model, etc., may be stored and executed by hardware processor(s) 142, which may be an embodiment of processor 804.

The computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions.

The computer system 800 may be coupled via bus 802 to a display 812, such as a liquid crystal display (LCD) (or touch screen), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. In some examples, the same direction information and command selections as cursor control may be implemented via receiving touches on a touch screen without a cursor.

The computing system 800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Such a user interface module, along with one or more of input device 814, cursor control 816, and display 812, may be used by clients 115 of FIG. 1A to interact with resource manager 112 of FIG. 1A to enter/define aspects or characteristics of a workflow(s), job(s), etc.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 800 may implement the techniques described herein using customized hard-wired logic, one or more ASICs or FPGAs, firmware and/or program logic which in combination with the computer system causes or programs computer system 800 to be a special-purpose machine. According to one example, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

The computer system 800 also includes a communication interface 818 coupled to bus 802. Communication interface 818 provides a two-way data communication coupling to one or more network links that are connected to one or more local networks. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN (or WAN component to communicated with a WAN). Wireless links may also be implemented. In any such implementation, communication interface 818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 818, which carry the digital data to and from computer system 800, are example forms of transmission media.

The computer system 800 can send messages and receive data, including program code, through the network(s), network link and communication interface 818. In the Internet example, a server might transmit a requested code for an application program through the Internet, the ISP, the local network and the communication interface 818. For example, runtime metrics regarding application QoS and resource usage can be tracked and relayed from resources in, e.g., tenant cloud 109 of FIG. 1A, to resource manager 112 of FIG. 1A. Resources can be added/removed/reassigned as needed (by resource manager 112 communicating via communication interface 818, to sustain, as closely as possible, the desired, e.g., paid-for QoS, for as long as possible throughout job runtime.

The received code may be executed by processor 804 as it is received, and/or stored in storage device 810, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
determining an applicable efficiency-quality of service (QoS) (EQ) rating for a workflow performable on a computing system based on historical EQ rating metrics;
predicting workload resource needs for initial deployment of the workflow in the computing system; and
providing runtime-sustained QoS in the computing system by dynamically reassigning one or more resources based on the determined EQ rating and predicted workload resource needs during performance of the workflow.

2. The method of claim 1, further comprising creating the historical EQ rating metrics by monitoring QoS and efficiency during runtime of an application to which the workflow belongs to create a historical time-series set of data, wherein efficiency is based on usage of the one or more resources.

3. The method of claim 2, further comprising training a predictive EQ algorithm with the historical time-series set of data to derive a machine learning model predicting the applicable EQ rating.

4. The method of claim 3, further comprising extrapolating a relationship trend identified by the machine learning model commensurate with the predicted workload resource needs, wherein the efficiency and the QoS are functions of one another.

5. The method of claim 1, further comprising determining computational complexity associated with at least one of an algorithm representative of the workflow or dataset metadata by comparing the computational complexity of the at least one of the algorithm or the dataset metadata with a computational complexity associated with historical workloads comparable to a current workload, and assigning the determined EQ rating to be an EQ rating comparable to that associated with the comparable historical workloads.

6. The method of claim 1, wherein the predicting of the workload resource needs comprises combining a paid-for QoS value with historical or estimated workload resource usage at one or more phases of a workflow.

7. The method of claim 1, wherein the predicting of the workload resource needs comprises maintaining the applicable EQ rating by virtue of a static QoS making up the applicable EQ rating met by scheduling usage of the one or more resources assigned based on the predicted workload resource needs throughout one or more phases of a workflow.

8. The method of claim 1, wherein providing the runtime-sustained QoS comprises tracking an average QoS during runtime of the workflow, and wherein the dynamically reassigning of the one or more resources comprises increasing the runtime-sustained QoS when the average QoS is less than a paid-for QoS.

9. The method of claim 8, wherein providing the runtime-sustained QoS comprises tracking the average QoS during runtime of the workflow, and wherein the dynamically reassigning of the one or more resources comprises decreasing the runtime-sustained QoS when the average QoS is greater than the paid-for QoS.

10. The method of claim 1, wherein providing the runtime-sustained QoS comprises tracking an average QoS during runtime of the workflow, and synchronizing the average QoS with a paid-for QoS through discounted billing associated with usage of the computing system.

11. A method, comprising:
determining an efficiency-quality of service (QoS) (EQ) rating for a workflow performable on a computing system by one of:
comparing current metadata of a current workload of the workflow with historical metadata of historical execution of the workload, and assigning an EQ rating commensurate with an EQ rating associated the historical execution of the workload; or
performing EQ rating modeling based on historical EQ rating metrics;
predicting workload resource needs for initial deployment of the process in the computing system; and
providing runtime-sustained QoS in the computing system by dynamically reassigning one or more resources based on the determined EQ rating and predicted workload resource needs during performance of the workflow.

12. The method of claim 11, further comprising creating the historical EQ rating metrics by monitoring QoS and efficiency regarding usage of the one or more resources during runtime of an application to which the workflow belongs to create a historical time-series set of data.

13. The method of claim 12, further comprising training a predictive EQ algorithm with the historical time-series set of data to derive a machine learning model predicting the EQ rating during the performance of the workflow.

14. The method of claim 13, further comprising extrapolating a relationship trend identified by the machine learning model commensurate with the predicted workload resource needs, wherein the efficiency and the QoS are functions of one another.

15. The method of claim 11, further comprising determining computational complexity associated with at least one of an algorithm representative of the workflow or dataset metadata by comparing the computational complexity of the at least one of the algorithm or the dataset metadata with a computational complexity associated with historical workloads comparable to a current workload, and assigning the determined EQ rating to be an EQ rating comparable to that associated with the comparable historical workloads.

16. A high performance computing (HPC) system, comprising:
a plurality of resources comprising at least one of computing and memory resources assignable to one or more workflows of an application executing on the HPC system;
a resource manager comprising a processor and a memory unit, the memory unit comprising code that when executed, causes the processor to:
determine an efficiency-quality of service (QoS) (EQ) rating for the one or more workflows;
predicting workload resource needs for initial deployment of the one or more workflows in the HPC system;
deploying the one or more workflows in the HPC system; and
adjusting at least one of an efficiency and QoS associated with the determined EQ rating to maintain a QoS level commensurate with a paid-for QoS throughout performance of the one or more workflows by dynamically reassigning one or more of the plurality of resources based on the determined EQ rating and predicted workload resource needs during performance of the one or more workflows.

17. The HPC system of claim 16, wherein the memory unit comprises code that further causes the processor to train a predictive EQ algorithm with a historical time-series set of data to derive a machine learning model predicting the applicable EQ rating.

18. The HPC system of claim 17, wherein the memory unit comprises code that further causes the processor to extrapolate a relationship trend identified by the machine learning model commensurate with the predicted workload resource needs, wherein the efficiency and the QoS are functions of one another.

19. The HPC system of claim 16, further comprising determining computational complexity associated with at least one of an algorithm representative of the one or more workflows or dataset metadata associated with the one or more workflows by comparing the computational complexity of the at least one of the algorithm or the dataset metadata with a computational complexity associated with historical workloads comparable to a current workload, and assigning the determined EQ rating to be an EQ rating comparable to that associated with the comparable historical workloads.

20. The HPC system of claim 16, wherein maintaining the QoS level comprises tracking an average QoS during runtime of the one or more workflows, and wherein the dynamically reassigning of the one or more resources comprises one of increasing the QoS level when the average QoS is less than a paid-for QoS, and decreasing the QoS level when the average QoS is greater than the paid-for QoS.
